(19) United States
(12) Patent Application Publication
(10) Pub. No.: US 2009/0094671 A1
(43) Pub. Date: Apr. 9, 2009

(54) System, Method and Apparatus for Providing Security in an IP-Based End User Device

(75) Inventors: Srikrishna Kurapati, Richardson, TX (US); Sudhindra Pundaleeka Herle, Dallas, TX (US)

Correspondence Address: CHALKER FLORES, LLP, 2711 LBJ FRWY, Suite 1036, DALLAS, TX, 75234, US

(73) Assignee: SIPERA SYSTEMS, INC., Richardson, TX (US)

(21) Appl. No.: 12/189,151

(22) Filed: Aug. 9, 2008

Related U.S. Application Data
(63) Continuation-in-part of application No. 10/917,771, filed on Aug. 13, 2004.
Application No. 10/917,771 is a continuation-in-part of application No. 11/502,244, filed on Aug. 9, 2006.
Application No. 11/502,244 is a continuation-in-part of application No. 11/769,609, filed on Jun. 27, 2007, now abandoned.
Application No. 11/769,609 is a continuation-in-part of application No. 11/776,509, filed on Jul. 11, 2007.
Application No. 11/776,509 is a continuation-in-part of application No. 11/776,549, filed on Jul. 11, 2007.
(60) Provisional application No. 60/955,037, filed on Aug. 10, 2007.

(51) Int. Cl. H04L 9/00

(52) U.S. Cl. 726/1

(57) ABSTRACT

The present invention provides a system, method and apparatus for providing security in an IP-based end user device, such personal computer clients, hard phones, soft phones, cellular phones, dual-mode phones, handheld communication devices, wireless communications devices and any other device capable of supporting real time IP-based applications. An application layer, a TCP/IP layer and a datalink layer of the IP-based end user device are monitored. Whenever an incoming session is detected and analyzed, the incoming session is accepted whenever one or more session security parameter(s) are satisfied and the incoming session is denied whenever the session security parameter(s) are not satisfied. Whenever an incoming packet is detected and analyzed, the incoming packet is processed whenever one or more packet security parameter(s) are satisfied and the incoming packet is dropped whenever the packet security parameter(s) are not satisfied.

### PRIORITY CLAIM

This patent application is: (a) a non-provisional application of U.S. provisional patent application 60/955,037 filed on Aug. 10, 2007; (b) a continuation-in-part application of U.S. patent application Ser. No. 10/917,771 filed Aug. 13, 2004 entitled “System and Method for Detecting and Preventing Denial of Service Attacks in a Communications System”; (c) a continuation-in-part application of U.S. patent application Ser. No. 11/502,244 filed Aug. 9, 2006 entitled “System and Method for Providing Network Level and Nodal Level Vulnerability Protection in VoIP Networks” which is a non-provisional application of U.S. Patent Application Ser. No. 60/706,950 filed Aug. 9, 2005; (d) a continuation-in-part application of U.S. patent application Ser. No. 11/769,609 filed Jun. 27, 2007 entitled “System, Method and Apparatus for Classifying Communications in a Communications System” which is a non-provisional application of U.S. Patent Application Ser. No. 60/817,445 filed Jun. 29, 2006; (e) a continuation-in-part application of U.S. patent application Ser. No. 11/776,509 filed Jul. 11, 2007 entitled “System, Method and Apparatus for Securely Exchanging Security Keys and Monitoring Links in a IP Communications Network” which is a non-provisional application of U.S. Patent Application Ser. No. 60/830,168 filed Jul. 12, 2006; and (f) a continuation-in-part application of U.S. patent application Ser. No. 11/776,549 filed Jul. 11, 2007 entitled “System, Method and Apparatus for Troubleshooting an IP Network” which is a non-provisional application of U.S. Patent Application Ser. No. 60/830,411 filed Jul. 12, 2006”. All of the foregoing applications are incorporated herein by reference in their entirety.

### FIELD OF THE INVENTION

The present invention relates generally to the field of communications and, more particularly, to a system, method and apparatus for providing security in an IP-based end user device.

### BACKGROUND OF THE INVENTION

Voice over Internet Protocol (“VoIP”) is the technology of choice in voice communications, whether as green-field deployment or as upgrade to existing Time Division Multiplex (“TDM”) networks, because of its demonstrated efficiencies and potential for productivity improvements. Voice Spam, Voice Mail Spam, stealth Denial of Service (“DoS”) (low frequency but constant calls to the same number) are all examples of problems that can completely disable any or all user devices and services, as well as the entire VoIP system itself. As has happened with email, once IP telephone calls can originate from anyplace in the world, at a near zero cost per call, such threats could impact anyone, anywhere.

Dealing with both internal and external threats to secure data networks from DoS, Distributed DoS (“DDoS”), and SPAM is well known to the data world. In voice networks, however, these same threats have significantly amplified impacts because the telephone and its related services are personal, real-time, and interactive. Imagine a phone ringing regularly in the middle of the night because of a spammer, or all phones in an enterprise ringing constantly due to a DoS attack, or entire voice mail systems being completely filled overnight with SPAM (and then each individual having to clear out their voice mailbox manually in the morning).

Meanwhile, the deployment of VoIP in enterprises, wireline carrier and wireless carrier networks is exploding. Extensive VoIP deployment is imminent in wireless networks as well (e.g., Unlicensed Mobile Access (“UMA”) networks). “Dual Mode” mobile phones are now providing voice services using VoIP over WiFi when available, and cellular elsewhere. These Dual Mode phones combine the better in-building coverage and reduced cost of WiFi hotspots with the broad geographic reach of cellular. Further, as the mobile phones are upgraded to the IP Multimedia Subsystem (“IMS”) standard, VoIP shall be ubiquitously used even over the wide area cellular networks.

The newest and soon to be ubiquitous VoIP, Video & Multimedia standard is the Session Initiation Protocol (“SIP”). In addition to SIP-based desk phones, SIP-based soft-phones are being incorporated into personal computers (“PCs”), Laptops, personal data assistants (“PDAs”), and Smart-phones (IMS). All of these VoIP communications systems, SIP, IMA and UMA, are all vulnerable to inappropriate VoIP signaling and/or media streams that can attack an individual or an entire enterprise. Current security management products for VoIP, although necessary and effective for what they do, cannot provide the needed functionality to stop VoIP specific attacks like Stealth DoS, Stealth DDoS, and Voice/Voice Mail Spam.

Stealth DoS attacks can include repeated but low-frequency calls to the same number. Unseen by Firewalls, just one or two calls a minute are enough to take an endpoint out-of-service. Much more troublesome are DDoS attacks. The first difficulty is determining that a DDoS attack is actually underway; the second is pinpointing the many sources. Both DoS and DDoS get much more difficult when the attacker hides by “spoofing” their IP address or caller ID, or if they use “zombies” to launch their attacks. Zombies are devices that have been taken over by the attacker, usually without end user knowledge. Targeted Stealth DoS and DDoS attacks can easily make it impossible for an enterprise to conduct business. The impacts to the enterprise could range from a few phones out of services, up to and including being completely out of business for some period of time. If that enterprise instead of owning/operating its own IP PBX were using hosted IP Centrex services provided by an Internet Telephony Service Provider (“ITSP”), the impact to the serving ITSP as well could be far beyond having to pay penalties for violating the SLA.

There is also the emerging problem of Voice and Voice Mail Spam. Because the incremental cost of launching such attacks approaches zero with VoIP, the situation could become as it is today where the majority of email traffic is spam. Actually, compared to email, Voice Spam is much more costly for both individuals and the enterprise, since it has to be dealt with in real-time, either by actually answering the unwanted call (which may not even be a call at all), or by sifting through all of one's voice mails to see which if any are indeed real. It even gets trickier because legitimate telemarketers are shifting to VoIP (Do Not Call lists are unenforceable in a VoIP), and since some individuals respond positively to such telemarketing, what is defined as Spam for one person may be acceptable to another. Further compounding the impact on both individuals and corporations, Voice Mail storage is costly and limited. A fairly simple attack scenario could be used to fill up the entire Voice Mail system of an enterprise so that every single employee would have to clear out their Voice Mail boxes before they could receive any legitimate ones, not to mention whatever messages callers were unable to leave in the meantime because the Voice Mail box capacity had been maxed out.

Certainly, repeated episodes of DoS, DDoS or Voice Spam, or perhaps even merely continued fears of such attacks by customers, trading partners and employees, could easily cause a dramatic reduction in an organization's ability to conduct business. In this circumstance, telecom vendors should expect most enterprises and consumers to take their business elsewhere. In some jurisdictions, local, state and federal government customers may even be forced by law to move to a new provider. Alternatively, and with equally devastating impacts, entire blocks of VoIP phones could be attacked, so that large subnets could effectively be rendered useless. Again, the subsequent business impact and loss of competitive positioning to impacted enterprise as well as the underlying VoIP vendors would be severe.

Existing security programs for end user devices only provide protection against attacks at the Internet Protocol (“IP”) layer and operating system level. These security programs do not protect the end user device against application level attacks or provide security at layer four and above. Moreover, these security programs are reactive in nature because they rely on updates and patches that are created and subsequently downloaded to the end user device only after a threat or vulnerability is discovered. Finally, these security programs are static because they do not adapt or interact (except for updates and patches) with the communications network.

As a result, there is a need for a system, method and apparatus for providing security in an IP-based end user device that is active and dynamic.

### SUMMARY OF THE INVENTION

The present invention provides a system, method and apparatus for providing security in an IP-based end user device that is active and dynamic. The present invention provides real time security for such applications as Voice over IP (“VoIP”), Instant messaging operating in such end user devices as personal computer (“PC”) clients, hard phones, soft phones, cellular phones, dual-mode phones, handheld communication devices, wireless communications devices and any other device capable of supporting real time IP-based applications.

For example, one embodiment of the present invention provides a method for providing security in an IP-based end user device (e.g., a mobile handset, hard phones, soft phones, cellular phones, dual-mode phones, handheld communication devices, wireless communication devices, a personal computer, a portable computer, a personal data assistant, a multimedia device or a combination thereof) by monitoring an application layer, a TCP/IP layer and a datalink layer of the IP-based end user device. Whenever an incoming session is detected and analyzed, the incoming session is accepted whenever one or more session security parameter(s) are satisfied and the incoming session is denied whenever the session security parameter(s) are not satisfied. Whenever an incoming packet is detected and analyzed, the incoming packet is processed whenever one or more packet security parameter(s) are satisfied and the incoming packet is dropped whenever the packet security parameter(s) are not satisfied. The session security parameter(s) and packet security parameters can be used to detect a malformed message, a rogue media anomaly, a rogue signaling anomaly, a flood attack, a protocol anomaly, an ARP poison anomaly, a configuration change anomaly, a DNS hijack anomaly, a spam attack, a man-in-the-middle attack, a spoofing attack or a combination thereof. Note that the present invention can be implemented as a computer program embodied on a computer readable medium in which each step is preformed by one or more code segments.

In another embodiment, the present invention provides a method for providing security in an IP-based end user device (e.g., a mobile handset, a computer, a portable computer, a personal data assistant, a multimedia device or a combination thereof) by detecting whether one or more Internet Protocol Communication Security Devices (“IPCS”) are in a path from the IP-based end user device to a network server and monitoring an application layer, a TCP/IP layer and a datalink layer of the IP-based end user device. Whenever the IPCS is detected, a secure communication channel is established with the IPCS, one or more security keys are negotiated with the IPCS, one or more system security parameters are obtained from the IPCS, and the IP-based end user device is configured with the obtained system security parameters. Whenever an incoming session is detected and analyzed, the incoming session is accepted whenever one or more session security parameter(s) are satisfied and the incoming session is denied whenever the session security parameter(s) are not satisfied. Whenever an outgoing session is detected and analyzed, the outgoing session is allowed whenever the session security parameter(s) are satisfied and the outgoing session is denied whenever the session security parameter(s) are not satisfied. Whenever an incoming packet is detected and analyzed, the incoming packet is processed whenever one or more packet security parameter(s) are satisfied and the incoming packet is dropped whenever the packet security parameter(s) are not satisfied. Whenever an outgoing packet is detected and analyzed, the outgoing packet is allowed whenever the packet security parameter(s) are satisfied and the outgoing packet is dropped whenever the packet security parameter(s) are not satisfied. Whenever a user interface command is detected, the user interface command is executed. The session security parameter(s) and packet security parameters can be used to detect a malformed message, a rogue media anomaly, a rogue signaling anomaly, a flood attack, a protocol anomaly, an ARP poison anomaly, a configuration change anomaly, a DNS hijack anomaly, a spam attack, a man-in-the-middle attack, a spoofing attack or a combination thereof. The incoming and outgoing packet(s) can be one or more data packets, voice packets, multimedia packets, signaling packets or a combination thereof.

In yet another embodiment, the present invention provides an IP-based communications apparatus that includes one or more processors (application layer and TCP/IP layer), one or more user interfaces connected to the processor(s), one or more communication interfaces (physical layer and datalink layer) connected to the processor(s), and one or more security modules. The security module(s): (a) monitor the application layer, the TCP/IP layer and the datalink layer; (b) whenever an incoming session is detected, determine whether the incoming session satisfies one or more session security parameters, accept the incoming session whenever the session security parameter(s) are satisfied, and deny the incoming session whenever the session security parameter(s) are not satisfied; and (c) whenever an incoming packet is detected, determine whether the incoming packet satisfies one or more packet security parameters, process the incoming packet whenever the packet security parameter(s) are satisfied, and drop the incoming packet whenever the packet security parameter(s) are not satisfied.

In another embodiment, the present invention provides a system that includes a network server, an IP-based end user device communicably connected to the network server via a network, and one or more IPCSs in a path from the IP-based end user device to the network server. The IP-based end user device includes one or more security modules that: (a) monitor an application layer, a TCP/IP layer and a datalink layer; (b) whenever an incoming session is detected, determine whether the incoming session satisfies one or more session security parameters, accept the incoming session whenever the session security parameter(s) are satisfied, and deny the incoming session whenever the session security parameter(s) are not satisfied; and (c) whenever an incoming packet is detected, determine whether the incoming packet satisfies one or more packet security parameters, process the incoming packet whenever the packet security parameter(s) are satisfied, and drop the incoming packet whenever the packet security parameter(s) are not satisfied.

The present invention is described in detail below with reference to the accompanying drawings.

### BRIEF DESCRIPTION OF THE DRAWINGS

The above and further advantages of the invention may be better understood by referring to the following description in conjunction with the accompanying drawings, in which:

FIG. 1 depicts a system for providing security in an IP-based end user device in accordance with one embodiment of the present invention;

FIG. 2 is a block diagram depicting an apparatus in accordance with one embodiment of the present invention;

FIG. 3 is a flow chart of a method for providing security in an IP-Based end user device in accordance with yet another embodiment of the present invention;

FIGS. 4A-4C are flow charts of a method for providing security in an IP-Based end user device in accordance with still another embodiment of the present invention; and

FIGS. 5A-5G are flow charts of a method for providing security in an IP-Based end user device in accordance with another embodiment of the present invention.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention. The discussion herein relates primarily to providing security to an Internet Protocol (“IP”) based end user device, such as a Voice Over IP (“VoIP”) phone, but it will be understood that the concepts of the present invention are applicable to providing security to a device in any packet-based communications network.

As used herein, VoIP and IMS (IP Multimedia Subsystem) is used as an example of a network technology to describe the solution. It is important to note that the invention still applies to any core network technology that uses IP as the transport layer for communication between the network entities. For instance, Unlicensed Mobile Access (“UMA”) network technology also applies to the current invention solution described herein. In addition, wireless access and wireless applications are used as example to describe the invention; however, the invention still applies to any access network and any application type that utilizes IP. Moreover, the invention applies to any device that end user may use to establish a secure connection with a trusted network entity in the core network, e.g., a laptop, a soft client, a desktop, a PDA or any other device. Moreover, Internet Protocol Communication Security (“IPCS”) is used as an example of an application layer security node to describe the present invention. However, the invention still applies to any network entity that requires knowledge of the Security Key assigned by the trusted network entity.

The following acronyms are used herein:

API Application Programming Interface

ARP Address Resolution Protocol

DHCP Dynamic Host Configuration Protocol

DNS Domain Name System

DSP Digital Signal Processor

HTTP Hypertext Transfer Protocol

IM Instant Messaging

IP Internet Protocol

IPCS Internet Protocol Communication Security

LCS Live Communications Server

MM Multimedia

RTP Real-time Transport Protocol

PSA Phone Security Agent

SIP Session Initiation Protocol

TCP Transport Control Protocol

UI User Interface

UMA Unlicensed Mobile Access

VLAN Virtual Local Area Network

VoIP Voice over IP

WiFi Wireless Local Area Network

The present invention provides a system, method and apparatus for providing security in an IP-based end user device that is active and dynamic. The present invention (hereinafter referred to as an IPCS phone security agent (“PSA”)) provides real time security for such applications as VoIP and IM operating in such end user devices as personal computer (“PC”) clients, hard phones, soft phones, cellular phones, dual-mode phones, handheld communication devices, wireless communications devices and any other device capable of supporting real time IP-based applications.

The PSA is a security solution for VoIP phones and other IP-based communications end user devices that work in conjunction with an IPCS (e.g., IPCS 310, 410, 510 or 610 provided by Sipera Systems, Inc.) in the network to provide comprehensive VoIP security. The PSA is capable of providing the following functionality:

1. Validate and verify incoming messages (SIP and RTP)

2. Digitally sign outbound messages (SIP and RTP)

3. Rogue media blocking

4. Rogue signaling blocking

5. Rate limiting inbound and outbound messages (SIP & RTP)

6. Mid-call encryption between two phones

7. Protocol Anomaly detection
a. ARP poisoning
b. Phone configuration change anomalies
c. DNS, DHCP, HTTP anomalies

8. UT Control of IPCS features
a. *SPAM, *TRUST via soft keys
b. Ring-tone control based on caller Trustscore
c. Viewing White list and Blacklist on phone
d. Enable, Disable mid-call encryption

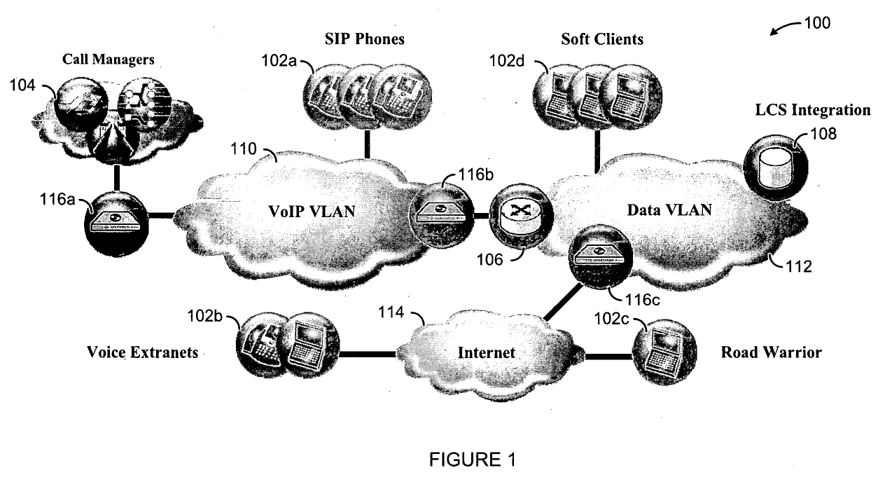

Now referring to FIG. 1, a system 100 for providing security in an IP-based end user device 102 (SIP Phones 102a, voice extranets 102b, road warriors 102c, soft clients 102d, etc.) in accordance with one embodiment of the present invention is shown. The system includes a network server or gateway (voice 104, data 106, live communications 108, multimedia, etc.), an IP-based end user device 102 communicably connected to the network server 104, 106 or 108 via a network (VoIP VLAN 110, Data VLAN 112, Internet 114, etc.), and one or more Internet Protocol Communication Security Devices (IPCS) 116 in a path from the IP-based end user device 102 to the network server or gateway 104, 106 or 108. In the example shown, IPCS 116a is in the path between network server 104 (call managers) and any IP-based end user devices 102a (SIP Phones) connected to VoIP VLAN 110, IPCS 116b is in the path between data server or gateway 106 and any IP-based end user devices 102a (SIP Phones) connected to VoIP VLAN 110, and IPCS 116c is in the path between both data server or gateway 106 and LCS Integration 108, and any IP-based end user devices 102b (voice extranets), 102c (road warrior) connected to Internet 114. IP-based end user devices 102d (soft clients) are also communicably coupled to Data VLAN 112. Those skilled in the art will recognize that FIG. 1 is only an example and the specific system architecture will vary according to the location, purpose and scope of a particular deployment.

The IP-based end user device can be a mobile handset, hard phones, soft phones, cellular phones, dual-mode phones, handheld communication devices, wireless communication devices, a personal computer, a portable computer, a personal data assistant, a multimedia device or a combination thereof. Each IP-based end user device 102 that uses the present invention includes one or more security modules that: (a) monitor an application layer, a TCP/IP layer and a datalink layer; (b) whenever an incoming session is detected, determine whether the incoming session satisfies one or more session security parameters, accept the incoming session whenever the session security parameter(s) are satisfied, and deny the incoming session whenever the session security parameter(s) are not satisfied; and (c) whenever an incoming packet is detected, determine whether the incoming packet satisfies one or more packet security parameters, process the incoming packet whenever the packet security parameter(s) are satisfied, and drop the incoming packet whenever the packet security parameter(s) are not satisfied. The session security parameter(s) and packet security parameters are used to detect a malformed message, a rogue media anomaly, a rogue signaling anomaly, a flood attack, a protocol anomaly, an ARP poison anomaly, a configuration change anomaly, a DNS hijack anomaly, a spam attack, a man-in-the-middle attack, a spoofing attack or a combination thereof. This process will be described in more detail below. The session security parameter(s) may include a black list, a white list, a trust score, a session anomaly characteristic or a combination thereof. The packet security parameter(s) may include an incoming session state model, an outgoing session state model, an encryption, a digital signature, one or more rate limits, a packet anomaly characteristic or a combination thereof.

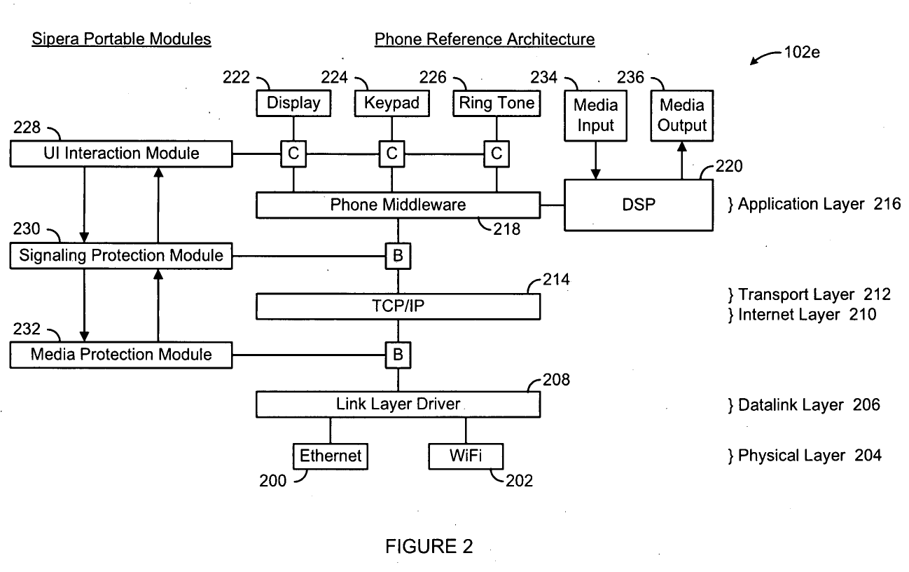

Referring now to FIG. 2, a block diagram depicting an apparatus 102e (phone) in accordance with one embodiment of the present invention is shown. In this example, apparatus 102e is a dual-mode device capable of connecting to a network via an Ethernet connection 200 and a WiFi network via a WiFi transceiver 202. A typical five layer reference architecture includes a physical layer 204 (Ethernet connection 200 and WiFi transceiver 202), a datalink layer 206 (link layer drivers 208), an Internet layer 210 and a transport layer 212 (combined as TCP/IP 214), and an application layer 216 (phone middleware 218). IP-based communications apparatus 102e includes one or more processors (e.g., DSP 220), one or more user interfaces (display 222, keypad 224, ring tone 226, etc.) connected to the phone middleware 218, which is connected to DSP 220 and TCP/IP 214, which are both connected to one or more communication interfaces (Ethernet connection 200 and WiFi transceiver 202) via the link layer drivers 208, and one or more security modules (e.g., user interface interaction module 228, signaling protection module 230 and media protection module 232). DSP 220 is also connected to media input 234 and media output 236. The security module(s) (228, 230 and 232): (a) monitor the application layer 216, the TCP/IP layer 214 and the datalink layer 206; (b) whenever an incoming session is detected, determine whether the incoming session satisfies one or more session security parameters, accept the incoming session whenever the session security parameter(s) are satisfied, and deny the incoming session whenever the session security parameter(s) are not satisfied; and (c) whenever an incoming packet is detected, determine whether the incoming packet satisfies one or more packet security parameters, process the incoming packet whenever the packet security parameter(s) are satisfied, and drop the incoming packet whenever the packet security parameter(s) are not satisfied. The session security parameter(s) and packet security parameters are used to detect a malformed message, a rogue media anomaly, a rogue signaling anomaly, a flood attack, a protocol anomaly, an ARP poison anomaly, a configuration change anomaly, a DNS hijack anomaly, a spam attack, a man-in-the-middle attack, a spoofing attack or a combination thereof. This process will be described in more detail below.

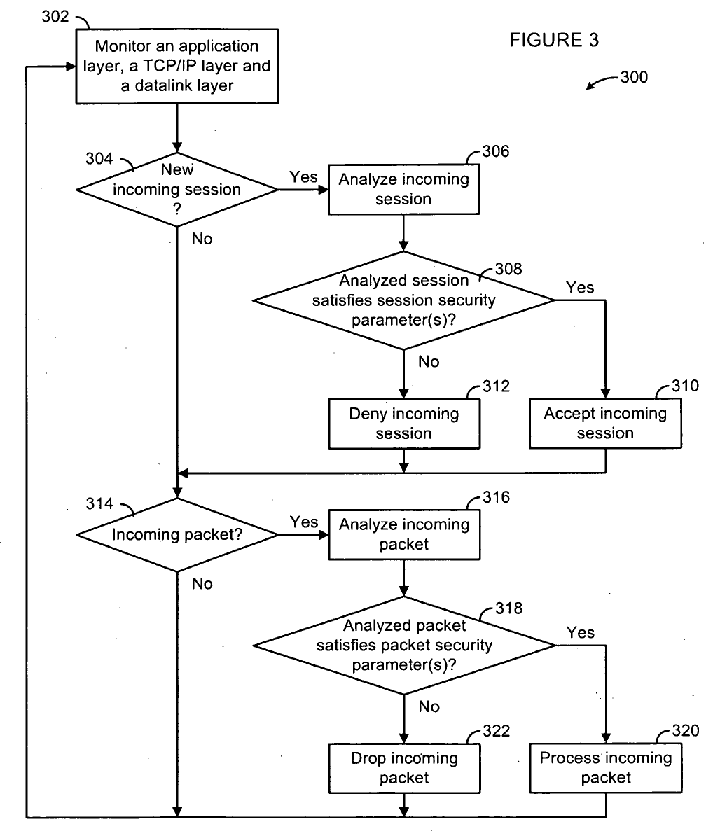

Now referring to FIG. 3, a flow chart of a method 300 for providing security in an IP-Based end user device 102 in accordance with yet another embodiment of the present invention is shown. The present invention monitors an application layer 216, a TCP/IP layer 214 and a datalink layer 206 of the IP-based end user device 102 in block 302. Whenever an incoming session is detected, as determined in decision block 304, the incoming session is analyzed in block 306. The incoming session is accepted in block 310 whenever one or more session security parameter(s) are satisfied, as determined in decision block 308, and the incoming session is denied in block 312 whenever the session security parameter(s) are not satisfied, as determined in decision block 308. Thereafter, the process continues to monitor an application layer 216, a TCP/IP layer 214 and a datalink layer 206 of the IP-based end user device 102 in block 302. Whenever an incoming packet is detected, as determined in decision block 314, the incoming packet is analyzed in block 316. The incoming packet is processed in block 320 whenever one or more packet security parameter(s) are satisfied, as determined in decision block 318, and the incoming packet is dropped in block 322 whenever the packet security parameter(s) are not satisfied, as determined in decision block 318. Thereafter, the process continues to monitor an application layer 216, a TCP/IP layer 214 and a datalink layer 206 of the IP-based end user device 102 in block 302. The session security parameter(s) and packet security parameters can be used to detect a malformed message, a rogue media anomaly, a rogue signaling anomaly, a flood attack, a protocol anomaly, an ARP poison anomaly, a configuration change anomaly, a DNS hijack anomaly, a spam attack, a man-in-the-middle attack, a spoofing attack or a combination thereof. Note that the present invention can be implemented as a computer program embodied on a computer readable medium in which each step is preformed by one or more code segments.

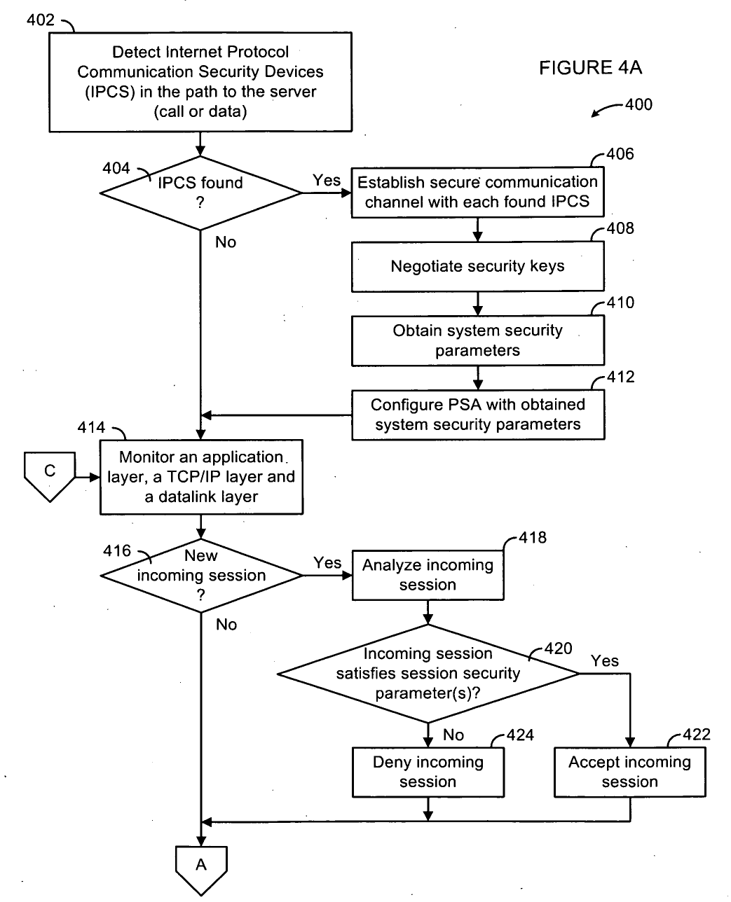

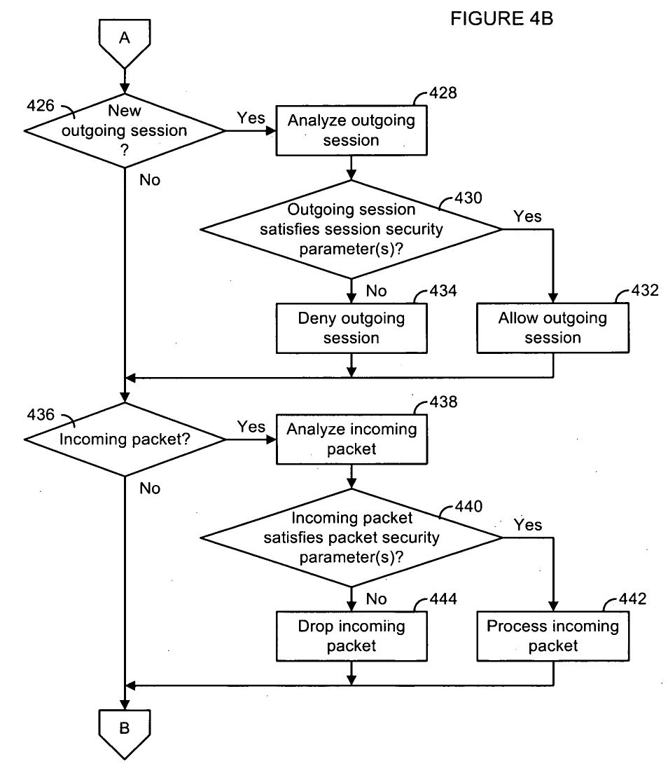

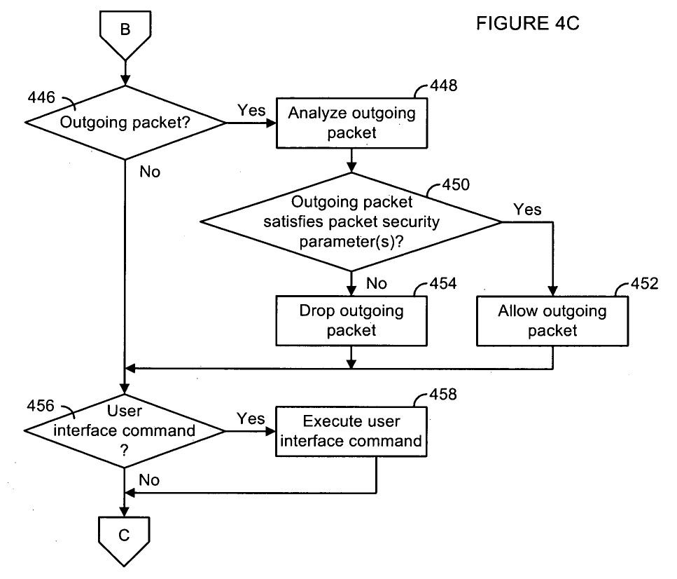

Referring now to FIGS. 4A-4C, flow charts of a method 400 for providing security in an IP-Based end user device 102 in accordance with still another embodiment of the present invention are shown. The present invention detects whether one or more IPCSs are in a path from the IP-based end user device to a network server in block 402. Although an IPCS is not required, the functionality of the present invention is greatly enhanced through the use of an IPCS protection the network servers, such as an IPCS-310 (or 410, 510, 610) provided by Sipera Systems Inc. Whenever the IPCS is detected, as determined in decision block 404, a secure communication channel is established with the IPCS in block 406, one or more security keys are negotiated with the IPCS in block 408, one or more system security parameters are obtained from the IPCS in block 410, and the IP-based end user device 102 is configured with the obtained system security parameters in block 412. Note that one or more new security keys may be received whenever the security key(s) associated with the secure communication channel are changed (e.g., on a per session or per call basis). Thereafter, or if an IPCS is not found, as determined in decision block 404, an application layer, a TCP/IP layer and a datalink layer of the IP-based end user device 102 are monitored in block 414. Whenever an incoming session is detected, as determined in decision block 416, the incoming session is analyzed in block 418. The incoming session is accepted in block 422 whenever one or more session security parameter(s) are satisfied, as determined in decision block 420, and the incoming session is denied in block 424 whenever the session security parameter(s) are not satisfied, as determined in decision block 420. Thereafter, the process continues to monitor an application layer 216, a TCP/IP layer 214 and a datalink layer 206 of the IP-based end user device 102 in block 414.

Whenever an outgoing session is detected, as determined in decision block 426, the outgoing session is analyzed in block 428. The outgoing session is allowed in block 432 whenever the session security parameter(s) are satisfied, as determined in decision block 430, and the outgoing session is denied in block 434 whenever the session security parameter(s) are not satisfied, as determined in decision block 430. Whenever an incoming packet is detected, as determined in decision block 436, the incoming packet is analyzed in block 438. The incoming packet is processed in block 442 whenever one or more packet security parameter(s) are satisfied, as determined in decision block 440, and the incoming packet is dropped in block 444 whenever the packet security parameter(s) are not satisfied, as determined in decision block 440.

Whenever an outgoing packet is detected, as determined in decision block 446, the outgoing packet is analyzed in block 448. The outgoing packet is allowed in block 452 whenever the packet security parameter(s) are satisfied, as determined in decision block 450, and the outgoing packet is dropped in block 454 whenever the packet security parameter(s) are not satisfied, as determined in decision block 450. Whenever a user interface command is detected, as determined in decision block 456, the user interface command is executed in block 458. Thereafter, the process continues to monitor an application layer 216, a TCP/IP layer 214 and a datalink layer 206 of the IP-based end user device 102 in block 414. The session security parameter(s) and packet security parameters can be used to detect a malformed message, a rogue media anomaly, a rogue signaling anomaly, a flood attack, a protocol anomaly, an ARP poison anomaly, a configuration change anomaly, a DNS hijack anomaly, a spam attack, a man-in-the-middle attack, a spoofing attack or a combination thereof. The incoming and outgoing packet(s) can be one or more data packets, voice packets, multimedia packets, signaling packets or a combination thereof. The user interface commands can be a SPAM command, a TRUST command, an enable encryption command, a disable encryption command, a display information command, a change preferences command or other desirable command.

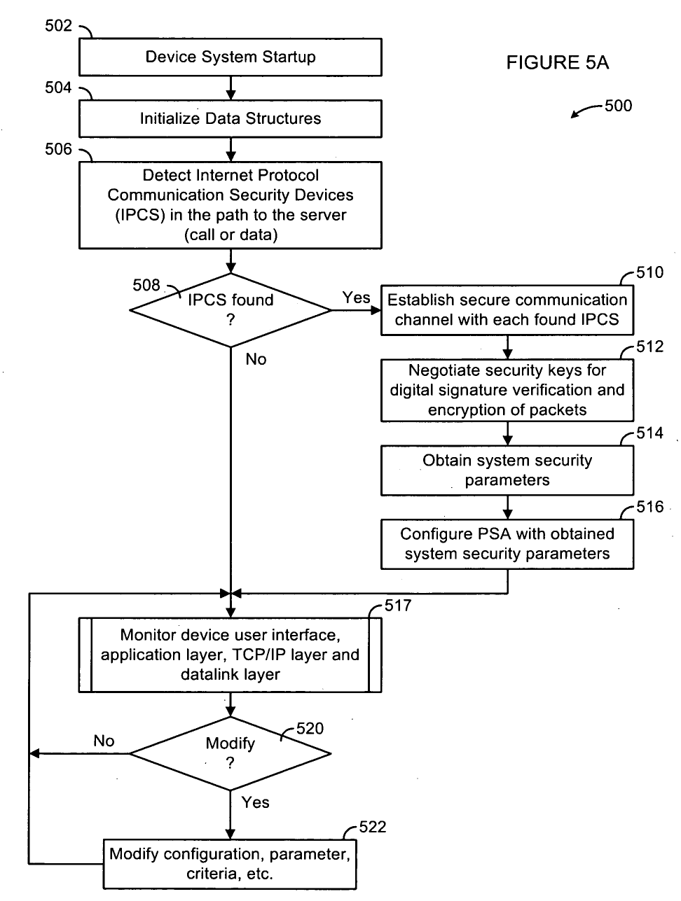

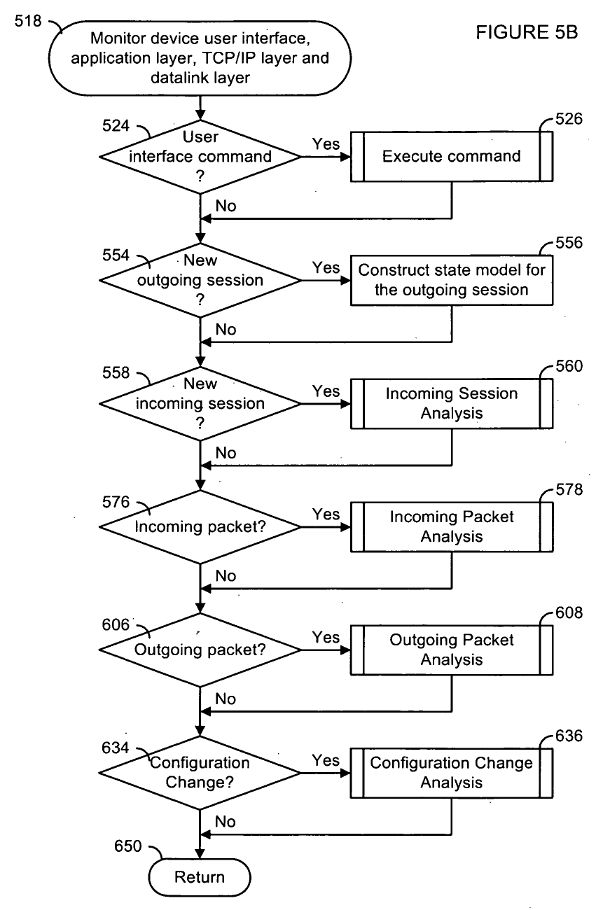

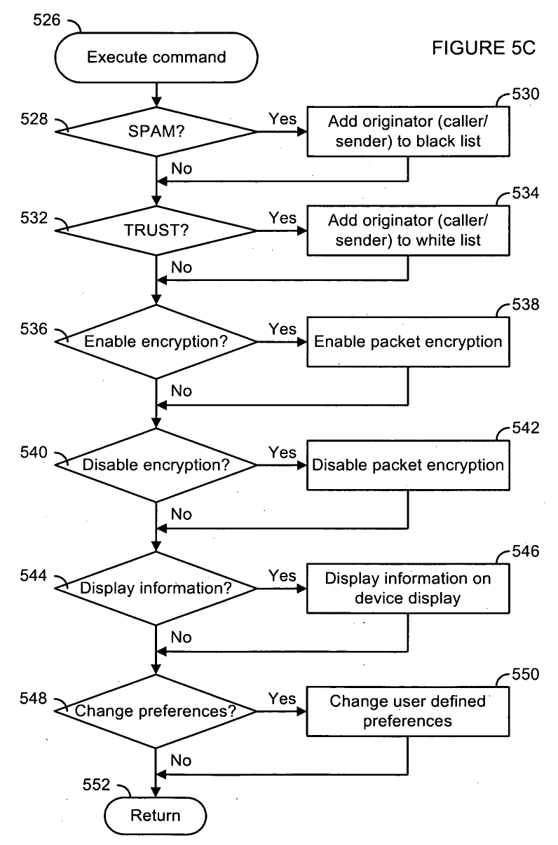

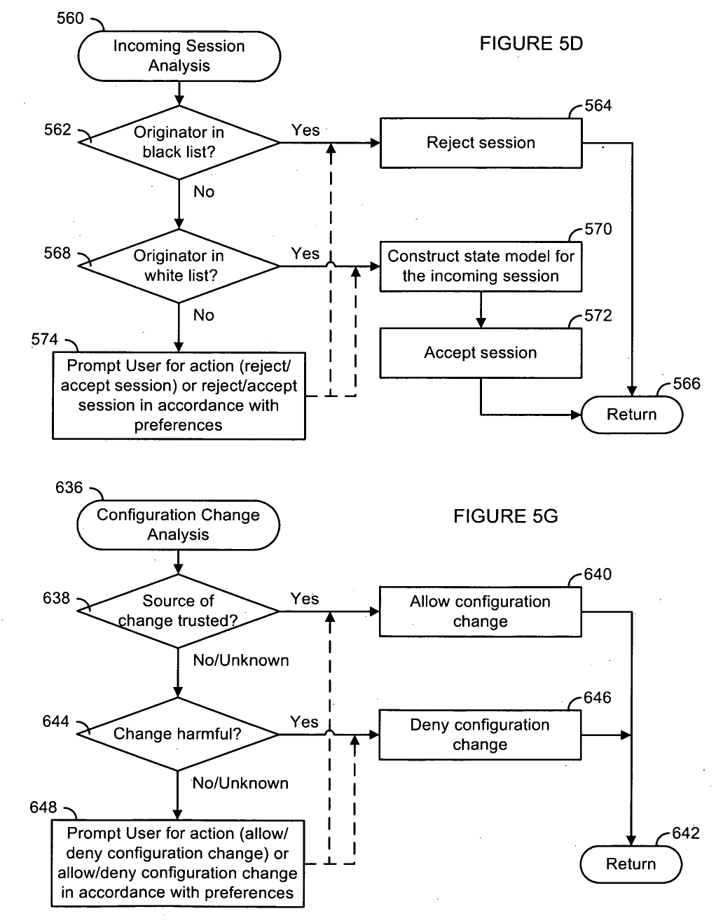

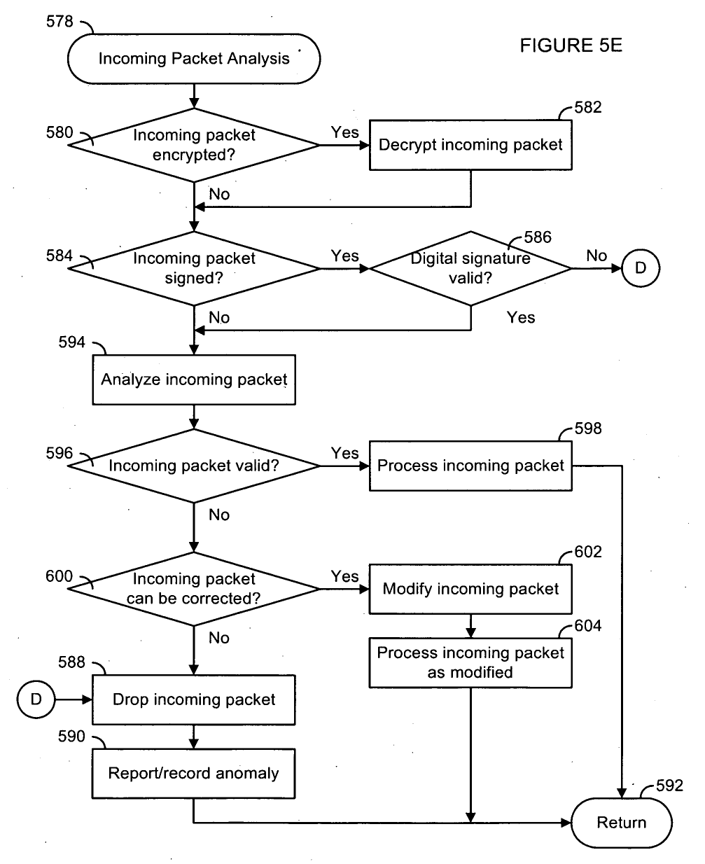

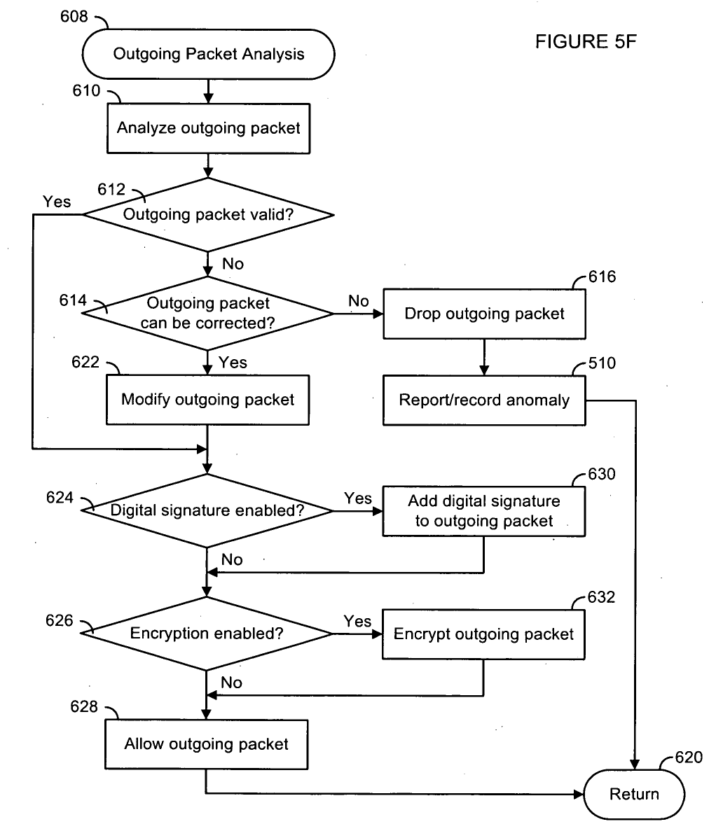

Now referring to FIGS. 5A-5G, flow charts of a method 500 for providing security in an IP-Based end user device 102 in accordance with another embodiment of the present invention are shown. The device 102 starts its system startup process in block 502, the present invention initializes one or more data structures in block 504 and detects whether one or more IPCSs are in a path from the IP-based end user device 102 to a network server in block 506. Whenever the IPCS is detected, as determined in decision block 508, a secure communication channel is established with the IPCS in block 510, one or more security keys for digital signature verification and encryption of packets are negotiated with the IPCS in block 512, one or more system security parameters are obtained from the IPCS in block 514, and the IP-based end user device 102 is configured with the obtained system security parameters in block 516. Note that one or more new security keys may be received whenever the security key(s) associated with the secure communication channel are changed (e.g., on a per session or per call basis). Thereafter, or if an IPCS is not found, as determined in decision block 508, an application layer, a TCP/IP layer and a datalink layer of the IP-based end user device 102 are monitored in block 518. The monitoring process 518 (FIG. 5B) will be described in more detail below. Periodically, a modification to the configuration, parameters, criteria or other aspects of the present invention may be required. In such a case, as determined in decision block 520, the configuration, parameters, criteria or other aspects are modified or changed in block 522. Thereafter, the monitoring process 518 continues.

The monitoring process 518 will now be described in reference to FIG. 5B. Whenever a user interface command is detected, as determined in decision block 524, an execute command process 526 is performed (see FIG. 5C). Whenever an outgoing session is detected, as determined in decision block 554, a state model for the outgoing session is constructed in block 556. Alternatively, the outgoing session can be analyzed such that the outgoing session is allowed whenever the session security parameter(s) are satisfied, and the outgoing session is denied whenever the session security parameter(s) are not satisfied. Whenever an incoming session is detected, as determined in decision block 558, an incoming session process 560 is performed (see FIG. 5D). Whenever an incoming packet detected, as determined in decision block 576, an incoming packet analysis process 578 is performed (see FIG. 5E). Whenever an outgoing packet is detected, as determined in decision block 606, an outgoing packet analysis process 608 is performed (see FIG. 5F). Whenever a configuration change is detected, as determined in decision block 634, a configuration change process 636 is performed (see FIG. 5G). Thereafter, the process returns in block 650 to continue monitoring an application layer 216, a TCP/IP layer 214 and a datalink layer 206 of the IP-based end user device 102 in process 500.

The execute command process 526 will now be described in reference to FIG. 5C. Whenever a SPAM command is detected, as determined in decision block 528, the originator (caller or sender) of an incoming session, a stored contact or a user entered contact is added to a black list in block 530. Whenever a TRUST command is detected, as determined in decision block 532, the originator of an incoming session, a stored contact or a user entered contact is added to a white list in block 534. Whenever an enable encryption command is detected, as determined in decision block 536, the present invention with encrypt/decrypt future packets to/from the originator of a session in response to a request from the originator or after acceptance by the originator in block 538. Whenever a disable encryption command is detected, as determined in decision block 540, the present invention with no longer encrypt/decrypt future packets to/from the originator of a session in block 542. Whenever a display information command is detected, as determined in decision block 544, information will be displayed to the user on the device display in block 546. Whenever a change preferences command is detected, as determined in decision block 548, the user defined preferences are changed in block 550. Thereafter, the process returns in block 552 to monitoring process 518.

The incoming session analysis process 560 will now be described in reference to FIG. 5D. If the originator is in the black list, as determined in decision block 562, the incoming session is rejected in block 564 and the process returns in block 566 to monitoring process 518. If, however, the originator is not in the black list, as determined in decision block 562, and the originator is in the white list, as determined in decision block 568, a state model for the incoming session is constructed in block 570, the incoming session is accepted in block 572 and the process returns in block 566 to monitoring process 518. If, however, the originator is not in the white list, as determined in decision block 568, the user is prompted for action (reject or accept the incoming session) or the incoming session is rejected or accepted in accordance with one or more defaults or preferences in block 574. Thereafter, the incoming session is either rejected in block 564 or accepted in blocks 570 and 572 and the process returns in block 566 to monitoring process 518.

The incoming packet analysis process 578 will now be described in reference to FIG. 5E. Whenever the incoming packet is encrypted, as determined in decision block 580, the incoming packet is decrypted in block 582. Whenever the incoming packet contains a digital signature, as determined in decision block 584, and the digital signature is not valid, as determined in decision block 586, the incoming packet is dropped in block 588, the anomaly is reported or recorded in block 590 and the process returns in block 592 to monitoring process 518. If, however, the incoming packet is not signed, as determined in decision block 584, or the digital signature is valid, as determined in decision block 586, the incoming packet is analyzed in block 594. If the incoming packet is valid (i.e., packet security parameter(s) are satisfied), as determined in decision block 596, the incoming packet is processed in block 598 and the process returns in block 592 to monitoring process 518. If, however, the incoming packet is not valid (i.e., packet security parameter(s) are not satisfied), as determined in decision block 596, and the incoming packet can be corrected, as determined in decision block 600, the incoming packet is modified in block 602, the incoming packet is processed as modified in block 604 and the process returns in block 592 to monitoring process 518. If, however, the incoming packet cannot be corrected, as determined in decision block 600, the incoming packet is dropped in block 588, the anomaly is reported or recorded in block 590 and the process returns in block 592 to monitoring process 518. The incoming packet(s) can be one or more data packets, voice packets, multimedia packets, signaling packets or a combination thereof.

The outgoing packet analysis process 608 will now be described in reference to FIG. 5F. The outgoing packet is analyzed in block 610. If the outgoing packet is not valid (i.e., packet security parameter(s) are not satisfied), as determined in decision block 612, and the outgoing packet cannot be corrected, as determined in decision block 614, the outgoing packet is dropped in block 616, the anomaly is reported or recorded in block 618 and the process returns in block 620 to monitoring process 518. If the outgoing packet can be corrected, as determined in decision block 614, the outgoing packet is modified in block 622. Thereafter, and if the outgoing packet is valid (i.e., packet security parameter(s) are satisfied), as determined in decision block 612, digital signatures are not enabled, as determined in decision block 624, and encryption is not enabled, as determined in decision block 626, the outgoing packet is allowed in block 628 (as modified, signed and/or encrypted) and the process returns in block 620 to monitoring process 518. If, however, digital signatures are enabled, as determined in decision block 624, a digital signature is added to the outgoing packet in block 630 and the packet is processed as previously described. If, however, encryption is enabled, as determined in decision block 626, the outgoing packet is encrypted in block 632 and the packet is processed as previously described. The outgoing packet(s) can be one or more data packets, voice packets, multimedia packets, signaling packets or a combination thereof.

The configuration change analysis process 636 will now be described in reference to FIG. 5G. If the source of the change is trusted, as determined in decision block 638, the configuration change is allowed in block 640 and the process returns in block 642 to monitoring process 518. If, however, the source of the change is unknown or not trusted, as determined in decision block 644, and the change is potentially harmful, as determined in decision block 644, the configuration change is denied in block 646 and the process returns in block 642 to monitoring process 518. If, however, the change is not harmful or has unknown effects, as determined in decision block 644, the user is prompted for action (allow or deny configuration change) or the configuration change accepted or denied in accordance with one or more defaults or preferences in block 648. Thereafter, the configuration change is either denied in block 646 or accepted in block 640 and the process returns in block 642 to monitoring process 518.

Additional features and specific examples of various features of the present invention will now be described. As previously described, the PSA dynamically discovers the presence of one or more IPCS in the path to the call or data server and establishes secure communication channels with them. As part of this, keys will be negotiated for signature, encryption, etc. PSA uses the dynamically negotiated keys to perform digital signature verification of incoming messages (both SIP and RTP). The same technique is used to digitally sign every outbound SIP, RTP message—which will be verified by the IPCS.

The PSA blocks rogue media and signaling by constructing a state call model based on parameters of incoming or outbound call or communications session. This model is used to verify rogue media arriving on ports other than the ones negotiated. It also blocks rogue media that arrives after the call has terminated. Similarly, signaling messages that arrive on ports other than the configured ports are dropped.

The PSA can also perform rate limiting of incoming and outgoing signaling messages—based on configured limits. Based on the state call model, PSA will rate limit incoming and outgoing media packets—to conform to the codec restrictions.

Whenever two phones that support PSA communicate with each other, they will also support the ability to enable or disable media encryption for the call—even in the middle. This feature must be explicitly enabled via the UI of the phone (softkey or some such mechanism) by both parties (initiator and responder).

In order to thwart man-in-the-middle and spoofing attacks, PSA will detect and block gratuitous ARP replies, DNS cache poisoning, DHCP spoofing, etc.

The PSA will expose the capabilities of the IPCS in the core network via one or more API functions. The UI of the phone will use these APIs to provide the following functionality:

Adding caller to white-list or black-list (“*SPAM”, “*TRUST”) via soft-key

Enabling or disabling mid-call encryption via soft-key

Displaying caller Trusts core on the LCD

Viewing the subscriber's white list or black list numbers

The features will be prioritized as follows:

1. SIP, RTP security

2. UI control

3. Other protocol security

4. Mid-Call encryption

PSA can be written in Portable ANSI C as OS independent, modular software. It can be easily ported to any modern OS and hardware with the following specifications:

RAM: 1 MB, Code: 2 MB

File System: 4 MB (Optional)

CPU: 10 MIPS ARM 7

The PSA can be used in dual-CPU smart phones or single-CPU “feature phones”. The APIs and porting guide are essentially the same in both cases.

In order to provide all the features described above, the PSA needs to intercept packets at various levels. And, to provide enhanced UI features, it needs to be informed of certain key press events—specifically to enable mid-call encryption and Whitelist/Blacklist interaction. The PSA API falls into two broad categories—API that controls the state machine and verification process and another that PSA requires from the underlying OS/Platform. The latter is called the “PSA Abstraction Layer”.

The PSA API will now be described. By convention, all PSA API functions start with the prefix “psa-”—indicating these are publicly available APIs whose implementation is provided by Sipera.

psa_init( )

This function must be called during system startup to initialize the PSA data structures. It must be called only once. void psa init(void);

psa_pkt_filter_in( )

This function must be called whenever the IP layer receives a packet from the lower layers (Ethernet/WiFi). This function will perform certain low-level anomaly detection, RTP anomalies, rogue-media and rogue-signaling detection, and ensure that ARP poisoning, etc. doesn't happen. The return value from this function will indicate either “DROP” or “PROCESS”—corresponding to valid or invalid packets. For packets that are marked DROP, PSA will generate an appropriate anomaly indicating the cause.
int psa_pkt_filter_in(void* pktbuf, int pktlen);
A return value of 0 implies normal (or valid) packet. Negative values indicate malformed or anomalous packets that must be dropped. The absolute value of the negative number is one of the enums of psa_incidence_t. This function can be called in interrupt context.

psa_pkt_filter_out( )

This function must be called just before the IP layer sends out a packet. This function performs certain internal housekeeping based on the content of the outgoing packet. void psa_pkt_filter_out(void* pktbuf, int pktlen);

It is safe to call this function from an interrupt context.

psa_sip_filter_in( )

This function must be called whenever the transport receives a valid SIP message. The return value of this function has the same semantics as psa_pkt_filter_in( ). int psa_sip_filter(unsigned char* sip_msg, int *msglen);
This function may modify the contents of the SIP message. The input/output parameter ‘msglen’ must contain the actual length of the buffer ‘sip msg’ and upon return it will be set to the new length of the buffer. This function must always be called in thread or process context—never in interrupt context.

psa_sip_filter_out( )

This function must be called just before the SIP layer sends out a SIP message (via the transport interface). This function may modify the contents of the outbound message. The input/output parameter ‘msglen’ must contain the actual length of the buffer ‘sip_msg’ and upon return it will be set to the new length of the buffer. The parameter ‘max_len’ indicates the maximum available space in the outbound message.
int psa_sip_filter_out(unsigned char* sip_msg, int* msglen, int max_len);
This function returns 0 on success and −ENOMEM if the output buffer is too small. This function must always be called in thread or process context.

psa_is_wl_caller( )

This predicate returns true if the caller is in the whitelist or false otherwise. In the event that the PSA is configured without any persistent storage, this function will always return true.
int psa_is_wl_caller(???);
This function must always be called in thread or process context—never in interrupt context.
psa_is_bl_caller( )
This predicate returns true if the caller is in the blacklist or false otherwise. In the event that the PSA is configured without any persistent storage, this function will always return false.
int psa_is_wl_caller(???);
This function must always be called in thread or process context—never in interrupt context.
psa_set_debug_level( )
This function is used to modify the currently active debug level of the PSA. Lower numbers imply less verbose messages and higher numbers imply more verbose messages. void psa_set_debug_level(int lev);
Note that setting this to really large numbers will greatly increase the amount of debug messages and potentially render the device inoperable.

psa_key_in( )

This function is used to inform PSA of an input key-press. PSA is only interested in a narrow range of keys: “*SPAM”, “*TRUST”, Enable Encryption, and Disable Encryption. Other functions can be executed using defined keys.

void psa_key_in(psa_key_t input_key);
enum psa_key_t
{

PSA_KEY_SPAM,
PSA_KEY_TRUST,
PSA_KEY_ENC_ENABLE,
PSA_KEY_ENC_DISABLE,

};

The PSA Abstraction Layer will now be described. By convention, all the PSAAL functions start with the prefix “sys_psa”—indicating that these are system dependent and must be provided by the SW integrator of the PSA. These functions are called by the core of PSA and generally, Sipera does not supply any implementation for these functions.

sys_psa_incident( )

This is the most important function of the PSA. It is used by PSA to notify the system of various attacks and incidences that are detected by the PSA.

void sys_psa_incident(psa_incidence_t, void* ctx, int ctx_len);
enum psa_incidence_t
{

PSA_MALFORMED_MSG_ANOMALY,
PSA_ROGUE_MEDIA_ANOMALY,
PSA_ROGUE_SIGNALING_ANOMALY,
PSA_FLOOD_ATTACK_ANOMALY,
PSA_PROTOCOL_ANOMALY,
PSA_ARP_POISON_ANOMALY,
PSA_CONFIG_CHANGE_ANOMALY,
PSA_DNS_HIJACK_ANOMAY,

} ;

Each anomaly type has an associated data—which is provided by “ctx” and “ctxlen”.

sys_psa_disable_int( )

This function must disable interrupts and return the current interrupt “mask” or “status”. The return value will be passed in a subsequent call to sys_psa_enable_int( ). PSA will treat the return value as an opaque quantity and not modify it in any way. unsigned long sys_psa_disable_int(void);

sys_psa_enable_int( )

This function is the opposite of the previous function. It must set the interrupt status to whatever is passed in. PSA will pass the same value that was returned in a prior call to sys_psa_disable_int( ).
void sys_psa_enable_int(unsigned long flags);

sys_psa_mutex_new( )

This function must create a new mutex and return an opaque handle to it. PSA will supply a human readable name to associate with the newly created mutex. An implementation is free to ignore the name; it is present for debuggability.

void* sys_psa_mutex_lock(const char* name);

sys_psa_mutex_lock( )

This function must lock the mutex identified by ‘handle’. If the mutex is locked, it must block until the mutex is available.
void sys_psa_mutex_lock(void* handle);

sys_psa_mutex_unlock( )

This function must unlock the mutex identified by ‘handle’ and unblock any waiting callers. void sys_psa_mutex_unlock(void* handle);

sys_psa_mutex_delete( )

This function must delete the mutex identified by ‘handle’.
void sys_psa_mutex_delete(void*handle);

sys_psa_debug_message( )

This function is used by PSA to print debug messages. This function is optional and may be absent in an implementation. The amount of messages printed is controlled by a corresponding call to “psa_set_debug_level( )”.
void sys_psa_debug_message(int lev, const char* str, int str len);

sys_psa display_ui( )

This function must display the given string on the LCD of the phone. The position and other attributes are left to the discretion of the phone SW integrator.
void sys_psa_display_ui(const char* str, int len);

sys_psa_get time( )

This function must return the current time in the argument ‘tm’. The function must return 0 on success and −1 on failure.

int sys_psa_get_time(struct psa_time* tm);
struct psa_time
{
unsigned long time_uts; /* UTS time in seconds since 1970 */

| | |
|---|---|
| long gmt_off; | /* GMT offset in seconds */ |
| long dst_correction; | /* DST correction to be applied (if any) */ |
| }; | |

The PSA Configuration Interface will now be described. In order for PSA to function effectively, it must be configured with certain data.

psa_update_config( )

This function configures PSA with the parameters of the call processing system.

| void psa_update_config(struct psa_host_config* new_config, ); | |
|---|---|
| struct psa_host | |
| { | |
| struct in_addr ip_addr; | |
| struct eth_addr[6]; | |
| }; | |
| struct psa_host_config | |
| { | |
| int n_callservers; | /* number of valid entries in the array */ |
| struct psa_host call_servers[4]; | |
| int n_dns_servers; | /* number of dns servers in the array */ |

```
  struct psa_host dns_servers[4];
  struct psa_host default_router;
};
```

The PSA ANSI C and POSIX Requirements will now be described. In addition to the functions documented in PSAAL, PSA also requires the following well known POSIX/ANSI functions. These functions are well know and are extensively described by other public documents.

| | |
|---|---|
| string.h | All the strxxx( ) and memxxx( ) functions |
| stdio.h | Common file I/O functions. This is optional; omitting support |
| | for file I/O will mean that PSA will not be able to read |
| | and write local Whitelist, Blacklist entries (among |
| | other things) |
| stdlib.h | Common memory management functions such as malloc, calloc, |
| | etc. In the event that functions meeting this interface are not |
| | available, Sipera will supply an OS independent implementation |
| | that can be used with minimal requirements on the |
| | host platform. |
| ctype.h | All the isxxx( ) functions as documented by ANSI. |

Additional information relevant to the present invention can be found in the following patent applications, the disclosure of which are incorporated by reference in their entirety: (a) U.S. provisional patent application 60/955,037 filed on Aug. 10, 2007; (b) U.S. patent application Ser. No. 10/917,771 filed Aug. 13, 2004; (c) U.S. patent application Ser. No. 11/502,244 filed Aug. 9, 2006; (d) U.S. Patent Application Ser. No. 60/706,950 filed Aug. 9, 2005; (e) U.S. patent application Ser. No. 11/769,609 filed Jun. 27, 2007; (f) U.S. Patent Application Ser. No. 60/817,445 filed Jun. 29, 2006; (g) U.S. patent application Ser. No. 11/776,509 filed Jul. 11, 2007; (h) U.S. Patent Application Ser. No. 60/830,168 filed Jul. 12, 2006; (i) U.S. patent application Ser. No. 11/776,549 filed Jul. 11, 2007; and ( ) U.S. Patent Application Ser. No. 60/830,411 filed Jul. 12, 2006”. All of the foregoing applications are incorporated herein by reference in their entirety.

It will be understood by those of skill in the art that information and signals may be represented using any of a variety of different technologies and techniques (e.g., data, instructions, commands, information, signals, bits, symbols, and chips may be represented by voltages, currents, electromagnetic waves, magnetic fields or particles, optical fields or particles, or any combination thereof). Likewise, the various illustrative logical blocks, modules, circuits, and algorithm steps described herein may be implemented as electronic hardware, computer software, or combinations of both, depending on the application and functionality. Moreover, the various logical blocks, modules, and circuits described herein may be implemented or performed with a general purpose processor (e.g., microprocessor, conventional processor, controller, microcontroller, state machine or combination of computing devices), a digital signal processor (“DSP”), an application specific integrated circuit (“ASIC”), a field programmable gate array (“FPGA”) or other programmable logic device, discrete gate or transistor logic, discrete hardware components, or any combination thereof designed to perform the functions described herein. Similarly, steps of a method or process described herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. Although preferred embodiments of the present invention have been described in detail, it will be understood by those skilled in the art that various modifications can be made therein without departing from the spirit and scope of the invention as set forth in the appended claims.

What is claimed is:

1. A method for providing security in an IP-based end user device, comprising the steps of:
monitoring an application layer, a TCP/IP layer and a datalink layer of the IP-based end user device;
whenever an incoming session is detected, determining whether the incoming session satisfies one or more session security parameters, accepting the incoming session whenever the session security parameter(s) are satisfied, and denying the incoming session whenever the session security parameter(s) are not satisfied; and
whenever an incoming packet is detected, determining whether the incoming packet satisfies one or more packet security parameters, processing the incoming packet whenever the packet security parameter(s) are satisfied, and dropping the incoming packet whenever the packet security parameter(s) are not satisfied.

2. The method as recited in claim 1, wherein:
the incoming session satisfies the session security parameter(s) whenever an originator of the incoming session is listed in a white list; and
the incoming session does not satisfy the session security parameter(s) whenever the originator of the incoming session is listed in a black list.

3. The method as recited in claim 1, further comprising the step of modifying the incoming packet whenever the incoming packet does not satisfy the packet security parameter(s) and the incoming packet can be corrected.

4. The method as recited in claim 1, further comprising the step of reporting or recording any incoming sessions that do not satisfy the session security parameter(s) and any incoming packets that do not satisfy the packet security parameter(s).

5. The method as recited in claim 1, further comprising the step of whenever an outgoing session is detected, determining whether the outgoing session satisfies the session security parameter(s), allowing the outgoing session whenever the session security parameter(s) are satisfied, and denying the outgoing session whenever the session security parameter(s) are not satisfied.

6. The method as recited in claim 5, wherein the session security parameter(s) comprise one or more incoming session security parameters and one or more outgoing session security parameters.

7. The method as recited in claim 1, further comprising the step of whenever an outgoing packet is detected, determining whether the outgoing packet satisfies the packet security parameter(s), allowing the outgoing packet whenever the packet security parameter(s) are satisfied, and dropping the outgoing packet whenever the packet security parameter(s) are not satisfied.

8. The method as recited in claim 7, wherein the packet security parameter(s) comprise one or more incoming packet security parameters and one or more outgoing packet security parameters.

9. The method as recited in claim 1, wherein the session security parameter(s) and packet security parameters are used to detect a malformed message, a rogue media anomaly, a rogue signaling anomaly, a flood attack, a protocol anomaly, an ARP poison anomaly, a configuration change anomaly, a DNS hijack anomaly, a spam attack, a man-in-the-middle attack, a spoofing attack or a combination thereof.

10. The method as recited in claim 1, wherein:
the session security parameter(s) comprise a black list, a white list, a trust score, a session anomaly characteristic or a combination thereof, and
the packet security parameter(s) comprise an incoming session state model, an outgoing session state model, an encryption, a digital signature, one or more rate limits, a packet anomaly characteristic or a combination thereof.

11. The method as recited in claim 1, further comprising the steps of:
initializing one or more data structures;
detecting whether one or more Internet Protocol Communication Security Devices (IPCS) are in a path from the IP-based end user device to a network server; and
whenever the IPCS is detected, establishing a secure communication channel with the IPCS, negotiating one or more security keys with the IPCS, obtaining one or more system security parameters from the IPCS, and configuring the IP-based end user device with the obtained system security parameters.

12. The method as recited in claim 11, further comprising the step of receiving one or more new security keys whenever the security key(s) associated with the secure communication channel are changed.

13. The method as recited in claim 12, wherein the security key is changed on a per session or per call basis.

14. The method as recited in claim 1, further comprising the steps of:
detecting a user interface command; and
executing the user interface command.

15. The method as recited in claim 14, wherein the user interface command comprises a SPAM command, a TRUST command, an enable encryption command, a disable encryption command, a display information command or a change preferences command.

16. The method as recited in claim 1, wherein:
the IP-based end user device comprises a mobile handset, a hard phone, a soft phone, a cellular phone, a dual-mode phone, a handheld communication device, a wireless communication device, a personal computer, a portable computer, a personal data assistant, a multimedia device or a combination thereof, and
the incoming and outgoing packet(s) comprise one or more data packets, voice packets, multimedia packets, signaling packets or a combination thereof.

17. A method for providing security in an IP-based end user device, comprising the steps of:
detecting whether one or more Internet Protocol Communication Security Devices (IPCS) are in a path from the IP-based end user device to a network server; and
whenever the IPCS is detected, establishing a secure communication channel with the IPCS, negotiating one or more security keys with the IPCS, obtaining one or more system security parameters from the IPCS, and configuring the IP-based end user device with the obtained system security parameters;
monitoring an application layer, a TCP/IP layer and a datalink layer of the IP-based end user device;
whenever an incoming session is detected, determining whether the incoming session satisfies one or more session security parameters, accepting the incoming session whenever the session security parameter(s) are satisfied, and denying the incoming session whenever the session security parameter(s) are not satisfied;
whenever an outgoing session is detected, determining whether the outgoing session satisfies the session security parameter(s), allowing the outgoing session whenever the session security parameter(s) are satisfied, and denying the outgoing session whenever the session security parameter(s) are not satisfied;
whenever an incoming packet is detected, determining whether the incoming packet satisfies one or more packet security parameters, processing the incoming packet whenever the packet security parameter(s) are satisfied, and dropping the incoming packet whenever the packet security parameter(s) are not satisfied;
whenever an outgoing packet is detected, determining whether the outgoing packet satisfies the packet security parameter(s), allowing the outgoing packet whenever the packet security parameter(s) are satisfied, and dropping the outgoing packet whenever the packet security parameter(s) are not satisfied;
whenever a user interface command is detected, executing the user interface command;
wherein the IP-based end user device comprises a mobile handset, a computer, a portable computer, a personal data assistant, a multimedia device or a combination thereof,
wherein the session security parameter(s) and packet security parameters are used to detect a malformed message, a rogue media anomaly, a rogue signaling anomaly, a flood attack, a protocol anomaly, an ARP poison anomaly, a configuration change anomaly, a DNS hijack anomaly, a spam attack, a man-in-the-middle attack, a spoofing attack or a combination thereof, and
the incoming and outgoing packet(s) comprise one or more data packets, voice packets, multimedia packets, signaling packets or a combination thereof.

18. A computer program embodied on a computer readable medium for providing security in an IP-based end user device, the computer program comprising:
a code segment for monitoring an application layer, a TCP/IP layer and a datalink layer of the IP-based end user device;
a code segment for whenever an incoming session is detected, determining whether the incoming session satisfies one or more session security parameters, accepting the incoming session whenever the session security parameter(s) are satisfied, and denying the incoming session whenever the session security parameter(s) are not satisfied; and
a code segment for whenever an incoming packet is detected, determining whether the incoming packet satisfies one or more packet security parameters, processing the incoming packet whenever the packet security parameter(s) are satisfied, and dropping the incoming packet whenever the packet security parameter(s) are not satisfied.

19. An IP-based communications apparatus comprising:
one or more processors comprising an application layer and a TCP/IP layer;
one or more user interfaces connected to the processor(s);
one or more communication interfaces connected to the processor(s) and comprising a physical layer and a datalink layer;
one or more security modules that: (a) monitor the application layer, the TCP/IP layer and the datalink layer; (b) whenever an incoming session is detected, determine whether the incoming session satisfies one or more session security parameters, accept the incoming session whenever the session security parameter(s) are satisfied, and deny the incoming session whenever the session security parameter(s) are not satisfied; and (c) whenever an incoming packet is detected, determine whether the incoming packet satisfies one or more packet security parameters, process the incoming packet whenever the packet security parameter(s) are satisfied, and drop the incoming packet whenever the packet security parameter(s) are not satisfied.

20. The apparatus as recited in claim 19, wherein:
the apparatus comprises a mobile handset, a computer, a portable computer, a personal data assistant, a multimedia device or a combination thereof, and
the incoming and outgoing packet(s) comprise one or more data packets, voice packets, multimedia packets, signaling packets or a combination thereof.

21. The apparatus as recited in claim 19, wherein the session security parameter(s) and packet security parameters are used to detect a malformed message, a rogue media anomaly, a rogue signaling anomaly, a flood attack, a protocol anomaly, an ARP poison anomaly, a configuration change anomaly, a DNS hijack anomaly, a spam attack, a man-in-the-middle attack, a spoofing attack or a combination thereof.

22. A system comprising:
a network server;
an IP-based end user device communicably connected to the network server via a network and having one or more security modules that: (a) monitor an application layer, a TCP/IP layer and a datalink layer; (b) whenever an incoming session is detected, determine whether the incoming session satisfies one or more session security parameters, accept the incoming session whenever the session security parameter(s) are satisfied, and deny the incoming session whenever the session security parameter(s) are not satisfied; and (c) whenever an incoming packet is detected, determine whether the incoming packet satisfies one or more packet security parameters, process the incoming packet whenever the packet security parameter(s) are satisfied, and drop the incoming packet whenever the packet security parameter(s) are not satisfied; and
one or more Internet Protocol Communication Security Devices (IPCS) in a path from the IP-based end user device to the network server.
